(19) United States
(12) Patent Application Publication
(10) Pub. No.: US 2021/0142249 A1
(43) Pub. Date: May 13, 2021

(54) CONSOLIDATED RESOURCE MANAGEMENT ACROSS MULTIPLE SERVICES

(71) Applicant: FinancialForce.com, Inc., San Francisco, CA (US)

(72) Inventors: Lori A. Ellsworth, Toronto (CA); Daniel Christian Brown, Bellevue, WA (US)

(73) Assignee: FinancialForce.com, Inc., San Francisco, CA (US)

(21) Appl. No.: 17/076,762

(22) Filed: Oct. 21, 2020

Related U.S. Application Data
(60) Provisional application No. 62/924,635, filed on Oct. 22, 2019.

(51) Int. Cl. G06Q 10/06; G06N 20/00

(52) U.S. Cl. CPC G06Q 10/06315; G06Q 10/06393; G06N 20/00

(57) ABSTRACT

Various embodiments include a computer-implemented method performed by an optimization engine. The method can include receiving a request to deploy a resource for one of multiple service lines, where each service line is operable independent of the other, the resource belongs to a pool of resources, and each resource has learned features regarding suitability for any of the service lines. The method can further include mediating the request to identify suitable resource(s) that satisfy the request, where suitability is determined based on the learned features output by a machine learning model based on inputs indicative of interactions between the plurality of service lines and the pool of resources. The method can further include deploying an identified resource that satisfies the request for the service line, wherein the identified resource is deployable among at least two or more of the service lines.

### CROSS-REFERENCE TO RELATED APPLICATIONS

This nonprovisional patent application claims the benefit of co-pending U.S. Provisional Patent Application No. 62/924,635 filed Oct. 22, 2019 and entitled “CONSOLIDATED RESOURCE MANAGEMENT ACROSS MULTIPLE SERVICES,” all of which is herein incorporated by reference for all purposes.

### FIELD

The disclosed teachings relate to systems and methods to consolidate resource management for multiple distinct service lines.

### BACKGROUND

Field service management (“FSM”) refers to the management of a company's resources employed at or en route to clients, rather than on company property. Examples include locating vehicles, managing worker activity, scheduling and dispatching work, ensuring driver safety, and integrating the management of such activities with inventory, billing, accounting and other back-office systems. FSM most commonly refers to companies who need to manage installation, service or repairs of systems or equipment. FSM can also refer to software and cloud-based platforms that aid in the management.

As companies seek to deliver various services to their clients, client demand grows for more expedited delivery of the services. In other words, consumers expect more from the same company, delivered quickly and in a seamless manner. For example, various high-tech companies offer multiple services that require delivery of different resources (e.g., hardware, software, staff, etc.) to clients. In many instances, the service lines offered by the same company are delegated to service providers that are managed as distinct and separate silos for different service lines. For example, a company may offer a computer product that requires delivery, installation, setup, and other field services. Accompanying service lines include troubleshooting and supplementary services such as learning services, managed services, and so on. The service lines are segregated into silos with separate and distinct resources that are managed independent of each other.

### SUMMARY

Various embodiments include at least one computer-implemented method performed by an optimization engine. The method can include receiving a request to deploy a resource for one of multiple service lines, where each service line is operable independent of the other, the resource belongs to a pool of resources, and each resource has learned features regarding suitability for any of the service lines. The method can further include mediating the request to identify suitable resource(s) that satisfy the request, where suitability is determined based on the learned features output by a machine learning model based on inputs indicative of interactions between the plurality of service lines and the pool of resources. The method can further include deploying an identified resource that satisfies the request for the service line, wherein the identified resource is deployable among at least two or more of the service lines.

### BRIEF DESCRIPTION OF THE DRAWINGS

Embodiments of the present technology will be described and explained through the use of the accompanying drawings.

FIG. 1 is a block diagram of a cloud-based system that can implement aspects of the disclosed embodiments.

FIG. 2 is a block diagram that depicts layers of a resource management engine.

FIG. 3 is a flow diagram that depicts dynamic resource management based on interactions between learned features of resources and service lines.

FIG. 4 is a flow diagram that illustrates a method for consolidating resource management across multiple service lines.

FIG. 5 illustrates an exemplary layered architecture for implementing a resource management optimization service, according to some examples.

FIG. 6 depicts an example of data objects that may include data to dynamically optimize deployment of resources in multiple service lines, according to some examples.

FIG. 7 depicts another example of an optimization engine, according to various examples.

FIG. 8 is a block diagram that illustrates an example processing system in which aspects of the disclosed technology can be implemented.

FIG. 9 illustrates examples of various computing platforms configured to provide various functionalities to components of a resource management optimization services to optimize resource deployment over multiple service lines.

The drawings, some components and/or operations may be separated into different blocks or combined into a single block when discussing some embodiments of the present technology. Moreover, while the technology is amenable to various modifications and alternative forms, specific embodiments have been shown by way of example in the drawings and are described in detail below. The intention, however, is not to limit the technology to the particular embodiments described herein. On the contrary, the technology is intended to cover all modifications, equivalents, and alternatives falling within the scope of the technology as defined by the appended embodiments.

### DETAILED DESCRIPTION

Various embodiments set forth below represent the necessary information to enable those skilled in the art to practice the embodiments, and illustrate the best mode of practicing the embodiments. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents thereof. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language, service, class, resource, specification, protocol, or other computing or network attributes. As used herein, “software” or “application” may also be used interchangeably or synonymously with, or refer to, a computer program, software, program, firmware, or any other term that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) or software, or any combination thereof, that may use one or more local, remote, distributed, networked, or computing cloud (hereafter “cloud”)-based computing resources (e.g., computers, clients, servers, tablets, notebooks, smart phones, cell phones, mobile computing platforms or tablets, and the like) to provide an application, operating system, or other computing environment, such as those described herein, without restriction or limitation to any particular implementation, design, configuration, instance, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, or state) may be used for processing and/or storage of varying quantities, types, structures, and formats of data, without restriction or limitation to any particular implementation, design, or configuration.

As used herein, data may be stored in various types of data structures including, but not limited to databases, data repositories, data warehouses, data stores, or other data structures configured to store data in various computer programming languages and formats in accordance with various types of structured and unstructured database schemas such as SQL, MySQL, NoSQL, DynamoDB™, etc. Also applicable are computer programming languages and formats similar or equivalent to those developed by data facility and computing providers such as Amazon® Web Services, Inc. of Seattle, Wash., FMP, Oracle®, Salesforce.com, Inc., or others, without limitation or restriction to any particular instance or implementation. DynamoDB™, Amazon Elasticsearch Service, Amazon Kinesis Data Streams (“KDS”)™, Amazon Kinesis Data Analytics, and the like, are examples of suitable technologies provide by Amazon Web Services (“AWS”).

Further, references to databases, data structures, or any type of data storage facility may include any embodiment as a local, remote, distributed, networked, cloud-based, or combined implementation thereof. For example, any portion of a service line may be configured to use different types of devices may generate (i.e., in the form of electronic messages or any other data in different forms, formats, layouts, data transfer protocols, and data storage schema for presentation on different types of devices that use, modify, or store data for purposes such as electronic messaging, audio or video rendering, content sharing, or like purposes. Any portion of a service line or a resource management service and/or optimization engine may communicate via application programming interfaces (“APIs”) with any other portion of any other service line or any other portion a resource management service and/or optimization engine.

In some examples, data may be formatted and transmitted (i.e., transferred over one or more data communication protocols) between computing resources using various types of data communication and transfer protocols such as Hypertext Transfer Protocol (“HTTP”), Transmission Control Protocol (“TCP”)/Internet Protocol (“IP”), Internet Relay Chat (“IRC”), SMS, text messaging, instant messaging (“IM”), File Transfer Protocol (“FTP”), or others, without limitation. As described herein, disclosed processes implemented as software may be programmed using Java®, JavaScript®, Scala, Python™, XML, HTML, and other data formats and programs, without limitation. Disclosed processes herein may also implement software such as Streaming SQL applications, browser applications (e.g., Firefox™) and/or web applications, among others. In some example, a browser application may implement a JavaScript framework, such as Ember.js, Meteor.js, ExtJS, AngularJS, and the like. References to various layers of an application architecture (e.g., application layer or data layer) may refer to a stacked layer application architecture such as the Open Systems Interconnect (“OSI”) model or others. Any of described elements or components set forth herein may be implemented as software, applications, executable code, application programming interfaces (“APIs”), processors, hardware, firmware, circuitry, or any combination thereof.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection between the elements can be physical, logical, or a combination thereof.

Demand for a single source of a variety of service lines has grown dramatically recently. Consumers expect a company that offers a product to provide delivery, installation, setup, troubleshooting, ongoing management, educational services, and so on, as one seamless experience. On the backend, a company that offers various related service lines manages the service lines as separate silos that each have resources designated specifically for that service line. As such, the resources of one service line are managed separately and independently from the resources of another service line. In some examples, data arrangements and data files storing resource-related data for a first service line may be stored separately from other data arrangements storing resource-related data for other service lines. The types of resources for each service line may be the same or different.

For example, many companies and/or organizations offer various service lines that require scheduling, deploying, and maintaining diverse resources. The resources can include software, hardware, machines, people, time, and so on. The resources are deployed through a variety of means (e.g., online computing devices, processors, memory, data storage, databases, etc.) and/or by various individuals to service sites. The service lines may be arranged and managed by distinct and separate entities, typically along the line of professional services, support services, field services, education or learning services, managed services, and so on. In other words, a customer-facing frontend service provider may be configured to offer different service lines that are deployed by service providers in managed silos. Conventional systems manage the service lines in separate and distinct silos for simplicity. However, managing resources in silos can create a bottleneck due to the variable demand for one service line that is disproportional to other service lines.

Various embodiments may be configured to provide data representing pooling resources of various service lines, as configured and stored in a repository, such as a common repository. Management of the resources may be consolidated across the multiple service lines. As such, the resources of one siloed service line can be deployed for other siloed service lines. To enable the ability of deploying resources across service lines, a resource management optimization service engine (“optimization engine”) processes information collected about the service lines, the pool of resources, and interactions between the services lines and resources. The information can include learned features output by one or more predictive data models, one or more of which may be generated by, or implemented as, machine learning (“ML”) algorithms/models. The learned features develop a knowledge base about the suitability of resources to understand which resources can be deployed across service lines.

For example, a subset of skills or a skill level required to effectively deploy one service line may overlap with another service line. In particular, a field service agent can develop a skill level suitable for an education service line. As such, the ML model can learn based on the type and amount of field service work that the field service agent is suitable as an instructor for a product education service line. The optimization engine can store learned features including resource profiles, skills, performance data, schedules, and other metrics information about the resources currently scheduled, expected in the future, and services where resources might be a good fit. The optimization engine interacts with a number of different fulfillment systems to accept resource requests, fulfill the requests, and update busy-times for the resources over time as the services are delivered, delayed, extended, and so on.

FIG. 1 is a block diagram of a cloud-based system that can implement an optimization engine according to some embodiments of the present disclosure. The system 10 includes components that consolidate management of various service lines. As shown, the components include a cloud-based platform 12, service provider server(s) 14, and client device(s) 16, all of which are interconnected over a network 18, such as the

Internet, to manage various siloed service lines. In some embodiments, the service provider server(s) 14 may be administered by one or more companies or organizations that may offer one or more service lines facilitated via one or more systems and/or methods as described herein. In some embodiments, the cloud-based platform 12 can provide the service lines offered by the service provider server(s) 14 to the client device(s) 16 that are consumers of the service lines. In some embodiments, the cloud-based platform 12 consolidates the management of services offered by the service provider server(s) 14 or client device(s) 16.

The network 18 may include any combination of private, public, wired, wireless portions, or any combination thereof or any other networking media. Data communicated over the network 18 may be encrypted or unencrypted at various locations or along different portions of the network 18. Each component of the system 10 may include combinations of hardware and/or software to process data, perform functions, communicate over the network 18, and the like. For example, any component of the system 10 may include a processor, memory or storage, a network transceiver, a display, an operating system (“OS”), and application software (e.g., for providing a user portal), and the like. Other components, hardware, and/or software included in the system 10 may implemented by persons having ordinary skill in the arts and, as such, need not be shown or discussed herein.

The cloud platform 12 can offer access to a shared pool of configurable computing resources, including servers, storage, applications, a software platform, networks, services, and the like, accessed by the service provider server(s) 14 to offer add-on applications to the client devices 16. The cloud platform 12 can support multiple tenants and may be referred to as a platform as a service (“PaaS”).

The service provider server(s) 14 may include any number of server computers that provide one or more service lines and/or consolidate cloud-based services, which allows entities to offer different services through a consolidated source and then manage the services by consolidating the management of the different services. Various goods or services can be deployed in accordance with a pre-arranged schedule and then dynamically allocate or reallocate resources across different service lines to improve utilization and efficiency. For example, an optimization engine can support the management and utilization of different resources across service lines. Although shown separate from the cloud platform 12, the service provider server(s) 14 may be included in the cloud platform 12.

The service provider server(s) 14, cloud-based platform 12, or other component of the system 10 may provide or administer a user interface (e.g., website) accessible from the client device(s) 16. The user interface may include features such as dashboard analytics to provide insight into how an entity is performing. Examples of entities that could benefit from consolidated management of services include software providers, hardware providers, professional service providers, energy and utilities providers, etc.

The client device(s) 16 can be operated by users (e.g., consumers or service providers) that interact with the system 10. Examples of client devices include computers (e.g., APPLE MACBOOK, LENOVO 440), tablet computers (e.g., APPLE IPAD, SAMSUNG NOTE, MICROSOFT SURFACE, etc.), smartphones (e.g., APPLE IPHONE, SAMSUNG GALAXY, etc.), and any other device that is capable of accessing the cloud-based platform 12 and/or service provider server(s) 14 over the network 18.

Examples of various systems and/or applications and algorithms may be configured to pool resources for implementation across one or more of various siloed service lines. The service lines are siloed in the sense that they can be and are usually managed separately. As such, the information required to manage each service line is limited to that service line. For example, the availability of any resource that belongs to a first service line may be unknown to a second service line (e.g., a first service line may be non-linkable to, or non-communicative with, a second service line). In one instance, a first service line may be configured to implement a dedicated or reserved set of resources (e.g., human resources, agents, field technicians, etc.), a dedicated or reserved subset of goods or services, as well as tools (e.g., computing devices, software applications, etc.), and the like, any of which may unavailable to other service lines. A common repository of resources can contain information about all the resources for various service lines. The optimization engine can select a suitable resource for a service line based on a task that is required of the service line. As such, the optimization engine manages a resource independent of a particular service line. Hence, a company can seamlessly deliver, for example, professional services, support services, and management services so that customers can consume services seamlessly and improve value to encourage adoption by the customer of a product.

For example, a company agent can address a customer request by generating a support ticket that opens a case that is closed once resolved. In one example, a request may involve project planning to arrange resources, a break/fix-based activity performed by a service worker, etc. There may be different resources managed by different groups of different systems that may use different routing algorithms, and different sources of resource master data. Problematically, various different offerings may have variability based, for example, on a stochastic basis. This may result in an inefficiency of resource utilization in the short term and long term. By using resources across service lines, the utilization of resources may be optimized beyond merely improving the use of time. In addition to optimizing utilization, the embodiments expedite delivery of services to customers in an efficient and harmonized manner.

Managing a pool of resources increases in complexity with more service lines and/or more resources. Various embodiments provide for systems and methods to overcome this issue by identifying suitable resources for particular service lines, routing the identified resources for a job, delivering the identified resources, and providing subsequent follow-up services. In conventional systems, if a resource of a siloed service line is unavailable, a customer may have to wait for a field service person to become available. By contrast, various disclosed embodiments may be configured to utilize a different service person (e.g., customer service agent) that is identified as having a suitable skill set to address the issue when no field service person is available and no customer service person available. In some examples, the different service person may be associated with another service line. Therefore, one or more resources of any type can be deployed remotely and across siloed service lines.

For example, a resource may be deployed to a particular site to address a particular problem. The optimization engine may determine that the same resource is suitable to address a different request from a different service line to address an issue at the same site. Thus, because there are already resources on site for one project, a support ticket can be addressed by the same service worker. Or if a resource that delivered an a solution is benched, a request for the resource can be routed to a professional consultant.

Thus, the optimization engine can bypass a support team for a service line if a suitable resource is available at a location. In some cases, the suitable resource may be associated with another service line. The optimization engine assigns the resource to the job, delivers the resource, monitors utilization of the resource, and receives information indicative of the performance of the resource. For example, the optimization engine can learn whether the resource developed any new capabilities on one project such that the resource is effective in other service lines. As such, the embodiments better utilize and/or enhance optimization of resources across different service lines.

FIG. 2 is a block diagram that depicts layers of an optimization engine. In some embodiments, the optimization engine dynamically allocates resources of siloed service lines according to the layered model depicted in FIG. 2. As shown, the lower layer is a resource management repository 260 that may be configured to store data representing at least indications of various resources for various service lines and accompanying information learned by the optimization engine about the resources based on their utilization and performance relative to different service lines. That is, resource management repository 260 may be configured to store a data arrangement that includes data configured to form a pool of resources and to accompany information learned about the resources regarding their utilization and performance relative to service lines.

According to some examples, a “service line” may refer to a subset of one or more resources (e.g., computing devices, human resources, parts, goods, equipment, tools, repair materials, etc.) and functionalities (e.g., processes) that may be identified and implemented to provide a service-based functionality. For example, in service line models implemented to facilitate an information technology (“IT”)-based products or services, each service line may be configured to manage dedicated hardware, software, human resources, and other resources to perform a disparate functionality.

Further, each service line may be defined or facilitated by a data arrangement that includes data representing resources, functionalities, timing, costs, prices, etc. to fulfill specified functionality of a service line.

In the example shown, the middle layer represents service lines 220 to 228 in different silos. The illustrated examples include professional services 220, support services 222, field services 224, education services 226, and managed services 228. Further, service lines may be configured effectively as silos and managed independently to provide, for example, information technology (“IT”) services and products.

Professional services 220 service line may include hardware and software configured to provide professional services, such as software developer services, IT and networking services, and the like, whereby hardware and software may be disposed in cross-service line layer 230, which may be a service provider computing platform or any portion thereof. Also, professional services 220 service line may include a human resource definition that describes roles, skills, etc. that may be used to provide professional services (e.g., software developer, quality assurance software engineer, etc.), whereby a human resource selector logic 232 may be configured to select optimal human resources (e.g., based on skills, scheduling, etc.) to service an issue in professional services line 220. Item manager 234 may include logic configured to identify items, such as parts, equipment (e.g., mobile computing device), tools (e.g., diagnostic software), materials, and the like, to facilitate a professional service. Also, finance engine 236 may be configured identify units of cost associated with implementation of each resource used to resolve an issue or address a condition associated with professional services line 220.

Note that cross-service line layer 230, which may be a service provider computing platform (or a portion thereof), human resource selector logic 232, item manager 234, and finance engine 236, as “a pool of resources,” each may be configured to provide hardware and/or software that, human resources, etc., to facilitate each of the remaining service lines, such as support services 222, field services 224, education services 226, and managed services 228. Support services line 222 may be configured to facilitate support services, such as a customer service agent functionalities, helpdesk functionalities, knowledge base functionalities, and the like. Field services line 224 may be configured to provide remote services by human resources have skills aligned with a task associated with a particular service line. Education services line 226 may be configured to provide education and teaching services (e.g., teaching a course in a software program as adapted for a particular corporate function). Managed services line 228 may be configured provide monitoring of the health of a company's hardware, software, and networking functions, as well as applying preventive activities to reduce disruptions in an organization's computing infrastructure.

In accordance with various embodiments, the resources available for service lines 220 to 228 may be managed across two or more of service lines 220 to 228. Thus, segregated service lines may be managed collectively as a single package of service lines or as related services.

The upper layer is a customer success layer, which may be implemented as a customer success platform controller 210. As shown, a customer success layer can include a customer success platform controller 210 configured to analyze various metrics and service line attributes, such as thresholds, schedules, or other parameters or metrics, to measure and quantify customer success. For example, a time metric may include indicating a time between receiving a service request and satisfying the requested service.

Examples of other parameters or metrics that can be used to measure customer success include multi-dimensional metrics such as a time metric, performance score, consumer feedback, etc. In some examples, customer success platform controller 210 may be configured to include an optimization engine, such as described in FIG. 3, at least in one embodiment.

Two or more of service lines 220-228 may be managed collectively to ensure customer success and increase the performance of a company by reducing underutilization of resources. Thus, service lines 220-228 may converge (or otherwise may be viewed or activated virtually as a logical representation as a combination of service lines) despite operating under different paradigms or different data arrangements or computing platforms. One or more of the resources may be selected for use across service lines 220-228. In some cases, a service (or service line) need not tap into resource repository 260. As a result, companies can offer numerous service lines while addressing customer requests more rapidly compared to conventional systems. Rapid delivery is exceedingly important if the product is software based because software becomes stale quickly compared to other types of offerings. For example, software products may be revised or upgraded relatively frequently, thereby necessitating implementation of one or more service lines 220-228 expeditiously (e.g., by implementing resources assigned to one service line to resolve an issue associated with another service line). Note that more or fewer numbers of service lines 220-228 may be implemented in other examples, as well as any other type of service line functionality (e.g., service lines 220-228 need not be limited to providing professional services, support services, field services, education services, or managed services). In some examples, a service line may directed to providing a particular product (e.g., a software product), as well as functionalities to resolve issues regarding the service line.

FIG. 3 is a block diagram that depicts data communications between resources and service lines through an optimization engine, which can dynamically map factors that characterize resources and service lines. As shown, a resource management optimization service 320 may include logic configured to implement an optimization engine 322, which may be implemented in hardware and/or software (or any combination thereof) to receive inputs regarding data representing interactions, which may be used to characterize a pool of resources or tasks that may be deployed dynamically in accordance with a schedule formulated and updated by the optimization engine. Resource management optimization service 320 and/or optimization engine 322 may be configured to receive service request data 301 to initiate functionality of resource management optimization service 320 and optimization engine 322 to dynamically (e.g., in real-time or near real-time) allocate resources across multiple service lines to service, address, resolve, and/or any condition or event associated with one or more portions of any service line. Optimization engine 322 may be configured to analyze a pool of available resources across multiple service lines, skillsets of human resources, availability of resources and other time constraints, and other data to generate a specific plan of action (e.g., to perform a project or complete a work order). Further, optimization engine 322 may be configured to generate service performance data 303 to transmit to computing devices associated with human resources identified in a plan of action (e.g., per work order or service ticket), as well as to any computing device associated with various service lines subject to the plan of action.

Examples of resource factors (e.g., attributes) used to dynamically allocate resources for different service lines may include a profiler 310, skill and certification manager 311, a scheduler 312 configured to determine or schedule availability for one or more tasks, a talent and performance management manager 313, a subcontractor manager 314, an intelligent staffing algorithm controller 315, and a supply and demand manager 316, any of which may be implemented with logic based on hardware or software, or a combination thereof. Profiler 310 can determine, generate, and control usage of profile data 310a, which may include data listing various features, properties, attributes, and characteristics of a resource, such as a customer service agent, a field agent, a skilled technician (e.g., an electrician, a computer technician, etc.), or any other human resource. A human resource may be an employee of an organization that implements logic in 300, a third-party subcontractor, or any other personnel, according to some examples. Profile data 310a may also include features, properties, attributes, and characteristics of goods (e.g., products) or services, associated with any service line. Also, profile data 310a may include features, properties, attributes, and characteristics of a tool (e.g., a computing device) or implement associated with repair, maintenance, or provisioning a good or service. Also, profile data 310a may include data representing attributes or characteristics of parts and repair materials. Profile data 310a may be populated manually and/or automatically based on learned information. Note further that profile data 310a including skills data may describe a set of the skills to deliver services in disparate service lines or organizations. For instance, a consultant can provide technical support on a software integration or development project, and may have skills to teach a class (e.g., in an education service line) about a product her or she typically implements.

Skill and certification manager 311 may be configured to determine, generate, and control usage of skill and certification data 311a, which may include data representing skills and certifications associated with, for example, a human resource (e.g., skills and certified skill sets of a field technician to perform a particular task). Skill and certification data 311a can include a list of one or more skills or certifications attributed or otherwise associated with a resource, whereby the list of one or more skills or certifications for a resource may be used by optimization engine 322 to identify a subset of resource (e.g., skilled technicians) based on skills included in profile data 310a.

Scheduler 312 may be configured to determine or schedule availability of a subset of resources (e.g., computing equipment availability, technician or agent availability, etc.) to address one or more tasks associated with any service line. Scheduler 312 can determine, generate, and control usage of scheduling data 312a as a function of available appointment times, operating times (e.g., hours of operation or access), transit times, estimated nominal task completion times (e.g., average, minimum completion times, maximum completion times, etc.), and any other time-related attribute or characteristic.

Talent and performance manager 313 may be configured to determine, generate, and control usage of talent and performance management data 313a, which may include data representing information and/or metrics available to attribute a value to a resource based on talent and/or performance metrics. For example, a value ranging from 1 to 10 (e.g., a range of ranked values) may be assigned or otherwise linked to a skill associated with a resource, such as a computer-based customer service agent, whereby a value is indicative of a level of expertise performing a task. In some examples, customer feedback may provide a contribution to establishing a level of expertise for a person's skill (e.g., a customer gives a technician a 5 out of 5 rating). As another example, a value ranging from 1 to 10 may be assigned or otherwise linked to a part, repair material, equipment, and/or a product, such as a computer peripheral device (e.g., USB drive, etc.) or a software product (e.g., anti-virus security software, etc.), whereby a value is indicative of a level of quality may be associated with an associated resource. For instance, a technician at remote geographic location may replace a capacitor in an air conditioning device that failed prior to a warranty date or an expected serviceable lifetime. Rating data can be transmitted wirelessly from the technician to resource management optimization service 320 to enable the feedback to influence, for example, inventory management (e.g., purchasing a higher quality capacitor or other part), as well as costs, etc.

Subcontractor manager 314 may be configured to determine, generate, and control usage of subcontractor management data 314a, which may include data representing features, attributes, and characteristics, and the like, of one or more subcontractors, as well as data representing subcontractor management-related data related to subcontractors that offer service lines. One or more service lines, or any portion thereof, may implemented or performed by one or more subcontractors as third party resources. By implementing subcontractors, and organization may be configured to increase resources responsive, for example, to peak or increased demand for goods or services. For example, an HVAC company may experience overwhelming requests to repair numerous faulty furnaces during a first very cold night of the winter season, and, in turn, the HVAC company may utilize subcontractors to consistently assist to service their customers and preserve their brand reputation.

Intelligent staffing algorithm controller 315 may be configured to determine, generate, and control usage of algorithmic data 315a, which may include data representing executable instructions of a computational algorithm that may be configured to perform machine learning or any other predictive computations based on inputs from optimization engine 322. The inputs from optimization engine 322 can relate to the performance of resources in different service lines. For example, resource management optimization service 320 can implement optimization engine 322 based on one or more activities performed by resources in association with various service lines. According to some examples, the inputs include data used to train a machine learning-based (“ML”-based) model for managing and optimizing resource allocation.

Supply and demand manager 316 may be configured to determine, generate, and control usage of supply and demand management data 316a, which may include data representing features, properties, attributes, and characteristics related to the supply and demand of different resources for different service lines. According to some examples, supply and demand management data 316a may be configured to include data representing requests and delivery (e.g., shipment) of products, goods, equipment, parts, repair materials, or any other service-related item. Also, supply and demand management data 316a may be configured to include data representing tracked or monitored consumption to maintain an inventory for one or more service lines.

Thus, system portion 302 of FIG. 3 may include logic to generate, maintain, store, and provision data representing categories, characteristics, or features (e.g., learned features) that may be used by, for example, optimization engine 322, to select suitable resources to form a pool of resources to enable resource management optimization service 320 particular objectives for tasks across two or more service lines by, for example, identifying resources across multiple data structures each associated with a different service line for use in multiple service lines, according to at least some embodiments.

System portion 304 of FIG. 3 may include data generated at optimization engine 322 and/or resource management optimization service 320, responsive to data generated to form a predictive model (e.g., an ML model) and to store predicted data in accordance with the predictive model. Examples of objectives or tasks for service lines may include quote data 340 representing a quote for a resource, project data 341 representing assignment of a resource to a project, case data 342 representing assignment of a resource to a case, break/fix data 343 representing assignment of a resource to an address a break/fix issue, request data 344 representing assignment of a request, shift data 345 representing a schedule to cover a shift (e.g., data representing a change in a schedule or resource based on time), and update data 346 representing an update a project status or progress, or may represent availability of a resource. In some examples, data 340-346 may be referred to resource deployment data, any of which may be implemented or generated to fulfill a request to deploy a resource, for example, in any of a number of service lines.

In some examples, quote data 340 may include project or work order specifics to accomplish a goal or an objective of servicing an issue or an asset associated with a service line. Optimization engine 322 may be configured to identify a subset of resources (e.g., internal employees or external subcontractors), and to transmit electronically quote data to the subset of resources. Project data 341 may include data specifying resources for a project including one or more human resources or roles, one or more assets to receive servicing, one or more pieces of equipment, tools, parts, etc., and other project-related data. Optimization engine 322 may be configured to generate case data 342, which may include data assigning a resource to a case for a particular service line (e.g., a particular customer and corresponding account or work order record).

Optimization engine 322 may be configured to generate break/fix data 343 representing assignment of one or more resources and project items (e.g., parts, equipment, etc.) to provide a break/fix-based model of service. In some cases, pricing and costs may be based on a per-service event (e.g., when a problem exists). In software-related and IT-related services, a break/fix-based model of service provides for consultation, education, and repairing hardware and software upgrades and defects upon request or event. Optimization engine 322 may be configured to generate request data 344 assigning a request to one or more resources, whereby a request may be an MS request, a managed service request, or the like. A request for a managed service provides for services (e.g., 24/7 monitoring, preventive servicing, helpdesk support, etc.), prices, and costs for managing continually one or more organization's service lines or products. In some cases, a managed service-based model of service using a third-party managed service provider (“MSP”), whereby pricing and costs may be based on a level of service provided.

Optimization engine 322 may be configured to generate shift data 345 representing an updated schedule to cover an absence of a resource (e.g., an employee is sick or a resource is unavailable). Further, optimization engine 322 may be configured to generate update data 346 representing an update a project status or progress, or may represent a change to an availability of a resource. Data 340-346 may be stored in repository 332. For example, information in a repository 332 may be stored for querying and usage for services, as mediated by optimization engine 332. In at least some examples, optimization engine 322 may be configured to operate as a centralized manager of service lines and resources over multiple service lines. Different combinations of resource features, attributes, and/or characteristics may be weighted relative to importance or relevancy of a resource for a specific type of project, thereby facilitating optimized routing decisions.

In some embodiments, the siloed service lines can involve a subcontractor (e.g., third party resources), such as a talent management component to educate, teach, and develop individuals, etc. Optimization engine 322 can identify suitable projects, cases, dispatches, etc. Thus, any service lines that may be siloed can utilize resources of any other service line. Further, implementations of optimization engine 322 and/or resource management optimization service 320 may facilitate avoiding a use of spreadsheets or other conventional methods of managing assets.

Therefore, optimization engine 322 may be configured to provide centralization, aggregation, and mediation of core master resource information available to a company or an organization. System 320 can then interact between resources and service lines so that data representing resources may reflect interactions and data exchanges (as well as resources implementations) among service lines in different silos. If a resource is used across service line boundaries, monitor 324 may include logic to detect resource usage over multiple service lines and generate notification data for management purposes. In addition, system 320 may be configured to avoid or reduce conflict among service lines by sharing information about the resources in backend of a computing platform and distributing resources in a non-linear manner in association frontend computing logic. Other examples of resource management features, attributes, and/or characteristics can include calendar data, history of work data, measurement data indicative of successful performance of activities in service lines (e.g., from a customer perspective). Other examples of service lines or related tasks include new projects, when the project is scheduled, locations where projects are performed, types of skilled required to fulfill requests, and customer-related information.

Optimization engine 322 may be configured to receive and mediate any query received for performing an activity for one or more service lines (e.g., via bidirectional electronic data communication). This allows for management by a company and outside of the company. Once a project is complete, any monitored performance metric may be detected at monitor 324 and reported to develop, modify, and/or generate predicted resource features associated with, for example, system portion 302. Based on bidirectional dialog and/or communications, optimization engine 322 may be configured to “predict” or “learn” data representing a value indicative of a capacity and amount of utilization of each resource, according to at least one example. In at least some examples, predictive model generator 330 may be configured to perform statistical analysis of one or more of data 310a-316a, service request data 301, service performance data 303, data 340-346, monitored data generate by monitor 324 (e.g., data associated with fulfilling or performing activities to resolve an issue in a service line), and any other sources of data to “learn,” or predict probabilistically, how to generate modifications of model data including, for example, data 310a-316a as well as implementation of predicted model data.

Optimization engine 322 and/or predictive model generator 330 may be configured to generate predicted data that may be used to characterize the suitability and availability of a resource for different service lines. For example, optimization engine 322 can collect inputs including an amount of time spent by a resource on a project or task, and re-characterize that resource for other projects based on the experience gained working on the first project (e.g., optimization engine 322 or predictive model generator 330 may be configured to enhance a skill level rating of a resource based on positive customer feedback). In some embodiments, optimization engine 322 or predictive model generator 330 may be configured to perform constraint optimization and scoring with ML criteria that defines success or applicability for a particular project (e.g., a scoring based on a type of project). Optimization engine 322 or predictive model generator 330 may be configured to also address supply and demand in response to variability over time, including utilization across multiple service lines. The learning can happen automatically as well as the brokering service provided by the optimization engine to intelligently manage a balance between supply and demand.

FIG. 4 is a flow diagram that illustrates a method for consolidating resource management across multiple services. In some embodiments, the method 400 is performed by the optimization engine. In step 402, a request is intercepted to deploy resources for a service line. In step 404, the intercepted request is mediated between the service line and the pool of resources based on features about the resources. For example, the features may include attributes or features (e.g., learned features) about the suitability of a resource across different service lines. In step 406, any identified resources are deployed to the service line. The deployed resource has been or can be deployed to a different service line. In step 408, the optimization engine monitors the utilization and performance of the deployed resources. In step 410, the features (e.g., predicted or learned features) of the deployed resources are updated based on the interactions between the service lines and the pool of resources as mediated by the optimization engine.

If a deployed resource can be utilized by another service line, the resource may be allocated to address or service a request for the other service line despite not being designated for that service line. For example, a resource that is assigned for fixing an issue can be determined as a resource that could be used in an education service line to aid in educating consumers. If the resource cannot be utilized by another resource, then a customer may have to wait for a resource designated for the service line to become available.

FIG. 5 illustrates an exemplary layered architecture for implementing a resource management optimization service, according to some examples. Diagram 500 depicts application stack (“stack”) 501, which is neither a comprehensive nor a fully inclusive layered architecture to optimize deployment of resources independent of associations with a specific service line (or assignment thereto). One or more elements depicted in diagram 500 of FIG. 5 may include structures and/or functions as similarly-named or similarly-numbered elements depicted in other drawings, or as otherwise described herein, in accordance with one or more examples, such as described relative to FIGS. 3 and 7, or any other figure or description herein.

Application stack 501 may include a resource management optimization service layer 550 upon application layer 540, which, in turn, may be disposed upon any number of lower layers (e.g., layers 503a to 503d). Resource management optimization service layer 550 may be configured to provide functionality and/or structure to implement an optimization engine application, as described herein. Resource management optimization service layer 550 and application layer 540 may be disposed on data exchange layer 503d, which may implemented using any programming language, such as HTML, JSON, XML, etc., or any other format to effect generation and communication of requests and responses among computing devices and computational resources constituting an enterprise and an enterprise resource planning (“ERP”) application and/or platform. Data exchange layer 503d may be disposed on a service layer 503c, which may provide a transfer protocol or architecture for exchanging data among networked applications. For example, service layer 503c may provide for a RESTful-compliant architecture and attendant web services to facilitate GET, PUT, POST, DELETE, and other methods or operations. In other examples, service layer 503c may provide, as an example, SOAP web services based on remote procedure calls (“RPCs”), or any other like services or protocols (e.g., APIs). Service layer 503c may be disposed on a transport layer 503b, which may include protocols to provide host-to-host communications for applications via an HTTP or HTTPS protocol, in at least this example. Transport layer 503b may be disposed on a network layer 503a, which, in at least this example, may include TCP/IP protocols and the like. Note that in accordance with some examples, layers 503a to 503d facilitate exchanges of data between, for example, optimization engine 520 and any number of service lines, whereby the exchange data may include data specifying interactions among one or more service lines.

As shown, electronic message moderation engine layer 550 may include (or may be layered upon) an application layer 540 that includes logic constituting an optimization engine layer 520, which may be layered upon a predictive model generator layer 510 and a monitoring logic layer 512. Monitoring logic layer 512 may be configured to monitor interaction data exchanged or communicated through layers 503a to 503d to detect utilization and performance of a pool of resources as mediated by optimization engine layer 520. Predictive model generator layer 510 may be configured to “predict” or “learn” optimized selections of resources based on evaluations of resource performances in real-time or near real-time. Resource management optimization service layer 550 or any of its components may be implemented based on technologies developed by FinancialForce.com, Inc., among other technologies.

Any of the described layers of FIG. 5 or any other processes described herein in relation to other figures may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including, but not limited to, Python™, ASP, ASP.net, .Net framework, Ruby, Ruby on Rails, C, Objective C, C++, C#, Adobe® Integrated Runtime™ (Adobe® AIR™) ActionScript™, Flex™, Lingo™, Java™, JSON, Javascript™, Ajax, Perl, COBOL, Fortran, ADA, XML, MXML, HTML, DHTML, XHTML, HTTP, XMPP, PHP, and others, including SQL™, SPARQL™, Turtle™, etc., as well as any proprietary application and software provided or developed by FinancialForce.com, Inc., or the like. The above described techniques may be varied and are not limited to the embodiments, examples or descriptions provided.

FIG. 6 depicts an example of data objects that may include data to dynamically optimize deployment of resources in multiple service lines, according to some examples. As shown, diagram 600 depicts an optimization engine 650, which optionally may include (or otherwise communicate with) a predictive model generator 651 that may be configured to generate a predictive data model of predicted feature data 601. Predictive model generator 651 may be configured to add or modify predicted feature data 601 based on monitoring data generated by monitor logic 624, which may be configured to monitor interaction data 655 exchanged interactions among service lines and a pool of resources as mediated by optimization engine 650. As shown, predicted feature data 601 may be stored in the data arrangement including data objects stored in data model repository 652. Note that the arrangement of data in diagram 600, including the illustrated hierarchy, is an example and is not intended to be limiting.

Service line case object 602 may be a data object that references, includes, or links to service line case data 601 that describes information associated with fulfillment of a request to deploy resources (e.g., associated with a work order or support ticket). Objective criteria data 611 may include data describing an object or goal of fulfilling a request, such as repairing a computing device, installation of a software program, or any other information technology-related actions. Resource requirement data 612 may include data describing resource requirements to meet the objective. For example, a resource requirement may recite a need for a software developer having a specific level of skill or a certification indicative sufficient competence in subset of programming languages. Item requirements data 613 may include data describing items to fulfill a service request, whereby an item may be an inanimate resource, such as a software product, computer hardware, a tool or equipment (e.g., a data network analyzer), or the like that may be used to fulfill the request. Time attribute data 614 may specify hours of operation, hours of availability one or more human resources, a project schedule including an expected completion date, and the like. Geographical (“Geo”) location data 615 may include a geographic location of an asset or a referenced location at which a service request is to be fulfilled.

Financial model data 616 includes data describing financial-related data requirements, such as payment terms, service level agreements, break/fix-related model information, managed service-related model information, and the like. Performance metrics data 617 may include subsets of data representing thresholds, ranges of values, and values that may be used to determine a level of performance. For example, an amount of labor used may have a cost threshold against which it measured. As another example, a length of time to fulfill a request may be measured against an expected range of values to determine an acceptable level of performance. In yet another example, performance may be evaluated against customer feedback as to whether a service request had been completed to their satisfaction. Other performance metrics may be implemented to measure and quantify customer success. Also, service line case data 601 may also include any other data 618.

Resource data object 603 may be a data object that references, includes, or links to resource data 620 that describes information regarding a human resource 630 or an item 640 (e.g., an inanimate resource). Data representing a human resource 630 may be characterized by any number of features, attributes, characteristics, etc. As shown, a resource 630 may be identified by identifier data 631 (e.g., a name, an employee number, contact information, etc.). In at least some cases, identifier data 631 may describe a resource 630 as a “subcontractor” having an associated billing rate. According to various embodiments, a human resource, whether an employee or a subcontractor, may be assigned to a specific service line through an associated based on service line identifier data 632. For example, a skilled software developer may be assigned to a professional services service line to provide technical assistance. However, based on one or more skills identified in skill data 633, that skilled software developer may be available to “teach” or “consult” in another service line (e.g., an education services line), regardless whether that developer is assigned to an education services line.

Skills data 633 may describe any skills for which human resource 630 may be deployed, and may be identified as having various levels of corresponding skill, as described in skill level data 635. Also, item data 640a may describe any item (e.g., parts, tools, equipment, product, etc.) that a human resource may be skilled or experienced in using. Performance feedback data 634 may be assigned to evaluate a level of expertise of a resource's skill.

Availability data 636 may include dates and times of day that a human resource is available for scheduling fulfillment of a service request. Scheduling data 637 may include data describing intervals of time that a human resource has been committed to perform activities to service any number of requests. Geo-location data 638 may describe data indicating a location of human resource 630 in real-time (or near real-time) to identify whether a human resources performing an activity at a location that may have other open (e.g., unfulfilled) service requests that human resource 630 may be able address, thereby reducing delays in satisfying customer demand. Data 639 representing data accesses to, for example, a knowledge base, or a record of data exchanges of interaction data 655 may be archived for analysis.

Data representing item 640 may be characterized by any number of features, attributes, characteristics, etc. that may describe an inanimate resource or asset to be serviced. As shown, data representing an item 640 may be characterized by features described as product data 641 (e.g., a type of product or brand name), service data 642 (e.g., operating a helpdesk or assisting in customer troubleshooting), tool data 643 that describes one or more tools, equipment data 644 that may describe one or more pieces of equipment, inventory data 645 may indicate an amount in inventory, attribute data 646 may describe any other item feature or characteristic, and resource data 630a may describe any human resource 630 may be skilled or experienced in using item 640.

To illustrate operation of predictive model generator 651 to modify predicted feature data 601 based on monitored interaction data 655, consider one example in which interaction data 655 indicates that a person identified as human resource 630 is at a remote location performing an activity to resolve an issue with which the person has yet to be identified (or certified) as having a skill identified in skills data 633 in a particular service line. Optimization engine 650 and/or predictive model generator 651 may further analyze interaction data 655 to identify (1.) a type of task in which the person was engaged, (20.) identify an amount of time to completion, (3.) determine that the person accessed the knowledge base to trouble-shoot “in real-time,” and (4.) identify a five (5)-star ranking (out of 5), thereby indicating that customer was very happy, Predictive model generator 651 may access data representing monitored interaction data 655 and predicted feature data 601 to probabilistically calculate that the person likely has mastered that skill, and, in response, may be configured to add that skill to skills data 633, with an optional low level of expertise in level data 635 (e.g., until the person successfully completes the task subsequently).

As another example, consider that human resource 630 is assigned to a professional services service line (e.g., as an expert software programmer), as identified in service line data 632, and is not assigned to any other service line. Next, consider that the expert software programmer is on-site at a location to develop software, whereby the location is identified in geolocation data 638. At the same site, another person who was to teach a class around the same time fell ill, thereby leaving a training service request unfulfilled. Optimization 650 and/or predictive model generator 651 may detect that the expert software programmer is at the location, and may be available to teach the class, even though that person is not assigned to an education services line. Therefore, a human resource having a skill may be deployed across two or more service lines to fulfill customer service requests. Therefore, optimization 650 and/or predictive model generator 651 may operate to continually (or aperiodically) monitor interaction data 655 and modify predicted feature data 601 (e.g., via training a predictive data model, such as a machine learning-based data model) so as to optimize deployment of resources over any number of service lines.

FIG. 7 depicts another example of an optimization engine, according to various examples. Diagram 700 depicts an optimization engine 764 configured to, at least in some examples, receive service request data 701a that may be configured to request deployment of a resource to perform service for one of any number of service lines, each service line being independent from each other. One or more elements depicted in diagram 700 of FIG. 7 may include structures and/or functions as similarly-named or similarly-numbered elements depicted in other drawings, or as otherwise described herein, in accordance with one or more examples or any other figure or description herein.

As shown, optimization engine 764 may include request evaluation logic 771, and resource deployment and service fulfillment logic 772, which, in turn, may include mediation logic 773. Further, optimization engine 764 may also include a data model controller 774, which, in turn, may include a performance processor 775, and an action generator 780, which may include a deployment data engine 781. Optimization engine 764 is configured to access repository 703, which may include feature/attribute data. As shown, repository 703 may include profile data 703a, scheduling data 703b, skill and certification data 703c, talent and performance data 703d, subcontractor management data 703e, algorithmic data 703f, and supply and demand data 703g, as well as any other data to facilitate deployment of resources. Note that data 703a-703g may be equivalent or similar to data described in FIG. 3. Referring back to FIGS. 7, diagram 700 also depicts optimization engine 764 being in electronic communication with (or including) a predictive model generator 720 and monitoring logic 730.

In some examples, monitor logic 730 may be configured to characterize one or more messages that may include interaction data via network 711 to determine or predict various features or attributes with which to optimize deployment of resources. In some examples, may be configured to identify attributes and corresponding attributes that may be matched, as a data pattern, against patterns of data including correlated datasets stored in, for example, model data within repository 703. Matching patterns may facilitate the correlation of message characteristics to assist in providing an optimal response during a process of fulfilling a service request.

Monitor logic 730 may be configured to characterize content of interaction message data to identify or determine one or more attributes such as, for example, data 703a-703g and/or data depicted in FIG. 6. Further, monitor logic 730 may be configured to detect and parse the various components of interaction message data, and further may be configured to perform analytics to analyze characteristics or attributes of one or more message components. As shown, monitor logic 730 may include a natural language processor 731 and a message component attribute determinator 732. Natural language processor 731 may be configured to ingest data to parse portions of an electronic message (e.g., using word stemming, etc.) for identifying components, such as a word or a phrase. Also, natural language processor 731 may be configured to derive or characterize a message as being directed to a particular resource, service line, item, customer, and the like. In some examples, natural language processor 731 may be configured to apply word embedding techniques in which components of an electronic message may be represented as a vector, which may be a data arrangement for implement machine learning, deep learning, and other artificial intelligence-related algorithmic functions, which may be performed by predictive model generator 720. Message component attribute determinator 732 may be configured to identify characteristics or attributes, as utilization-related data and performance-related data. For example, interaction message data received from a service line may specify a usage rate of a resource which, when analyzed against the performance metric, may classify that resource as “underutilized.” Thereafter, optimization engine 764 may be configured to identify and assign fulfillment of a service request to an underutilized resource to ensure consistent performance of an organization.

Predictive model generator 720 is shown to include a data correlator 733, which may be configured to statistically analyze components and attributes of interaction message data and feature/attribute data 703a-703g to identify predictive relationships between, for example, an attribute and a value predicting a likelihood that a modified value of any of the feature/attribute data may invoke a specific predictive action, that, in turn, may further enhance or optimize deployment of resources.

According to some embodiments, data correlator 733 may be configured to classify and/or quantify various “features,” or “attributes” as a function of utilization rate data and performance level data that may be fed back from service lines implementing a combination of deployed resources. In some instances, the classification may be performed by, for example, applying machine learning or deep learning techniques, or the like.

In one example, data correlator 733 may be configured to segregate, separate, or distinguish a number of data points (e.g., vector data) representing similar (or statistically similar) attributes or received electronic messages, thereby forming one or more sets of clustered data. Clusters of data (e.g., predictively grouped data) may be grouped or clustered about a particular attribute of the data, such as a type of resource, a type of skill, an availability of a resource, time-related data (e.g., whether a task is past expected time of completion), a type of customer, a degree of urgency for an issue (e.g., potential financial losses due to unfulfilled service requests), or any other attribute, characteristic, parameter or the like. In at least one example, a cluster of data may define a subset of resources having one or more similarities (e.g., a statistically same topic) that may be configured to characterize a subset of resources for purposes of selecting and deploying one or more resources in an optimal manner.

While any number of techniques may be implemented, data correlator 733 may apply “k-means clustering,” or any other clustering data identification techniques to form clustered sets of data that may be analyzed to determine or learn optimal classifications of data and associated predictive responses thereto. In some examples, data correlator 733 maybe configured to detect patterns or classifications among datasets associated with feature/attribute data 703a-703g and other data through the use of Bayesian networks, clustering analysis, as well as other known machine learning techniques or deep-learning techniques (e.g., including any known artificial intelligence techniques, or any of k-NN algorithms, linear support vector machine (“SVM”) algorithm, regression and variants thereof (e.g., linear regression, non-linear regression, etc.), Bayesian inferences and the like, including classification algorithms, such as Naïve Bayes classifiers, or any other statistical or empirical technique).

In the example shown, data correlator 733 may be configured to implement any number of statistical analytic programs, machine-learning applications, deep-learning applications, and the like. Data correlator 733 is shown to have access to any number of predictive models, such as predictive model 790a, 790b, and 790c, among others. In this implementation, predictive data model 790a may be configured to implement one of any type of neuronal networks to predict an action (e.g., to modify, add, create, delete, etc. any of the data in predicted feature data 601 of FIG. 6 or in repository 703 of FIG. 7), or to take no action. In this case, a neural network model 790a includes a set of inputs 791 and any number of “hidden” or intermediate computational nodes 792 and 793, whereby one or more weights 797 may be implemented and adjusted (e.g., in response to training). Also shown, is a set of predicted outputs 794, such as “modify predicted data” or “take no action,” among any other type of output. Note that modifying predicted data may be equivalent to forming “learned” features based on training, for example, a machine learning-based algorithm.

Further to optimization engine 764, data model controller 774 may be configured to analyze monitored interaction data from monitor logic 730, and further configured to control operation of predictive model generator 720 responsive to, for example, and output of performance processor 775. In this example, performance processor 775 may be configured to evaluate monitored interaction data to extract parametric values and metric values that may be compared against various performance criteria. In some examples, performance processor 775 may be configured to identify subsets of underperforming deployment of resources, and may further be configured to instruct predictive model generator 720 to modify one or more values of data in repository 703.

Action generator 780 may be configured to generate one or more subsets of resource deployment data, such as resource deployment data 304 of FIG. 3. One or more of resource deployment data 304 may be generated at deployment data engine 781 and transmitted as data 701c to a repository 710 that includes data arrangements of resource deployment data. Further, any of subset of resource deployment data may be communicated via network 711 to one or more service lines.

Any of described elements or components set forth in FIG. 7, and any other figure herein, may be implemented as software, applications, executable code, application programming interfaces (“APIs”), processors, hardware, firmware, circuitry, or any combination thereof.

In some examples, computing devices using computer programs or software applications may be used to implement multi-service line resource allocations and resource management optimization services, using computer programming and formatting languages such as Java®, JavaScript®, Python®, HTML, HTML5, XML, and various data handling techniques and schemas.

FIG. 8 is a block diagram illustrating an example of a processing system 800 in which at least some aspects described herein can be implemented. The processing system 800 represents a system that can run any of the methods/algorithms described herein. For example, any component of the system 10 may include or be part of a processing system 800. The processing system 800 may include one or more processing devices, which may be coupled to each other via a network or multiple networks.

In the illustrated embodiment, the processing system 800 includes one or more processors 802, memory 804, a communication device 806, and one or more input/output (I/O) devices 808, all coupled to each other through an interconnect 810. The interconnect 810 may be or include one or more conductive traces, buses, point-to-point connections, controllers, adapters and/or other conventional connection devices. Each of the processor(s) 802 may be or include, for example, one or more general-purpose programmable microprocessors or microprocessor cores, microcontrollers, application specific integrated circuits (ASICs), programmable gate arrays, or the like, or a combination of such devices.

The processor(s) 802 control the overall operation of the processing system 800. Memory 804 may be or include one or more physical storage devices, which may be in the form of random-access memory (RAM), read-only memory (ROM) (which may be erasable and programmable), flash memory, miniature hard disk drive, or other suitable type of storage device, or a combination of such devices. Memory 804 may store data and instructions that configure the processor(s) 802 to execute operations in accordance with the techniques described above. The communication device 806 may be or include, for example, an Ethernet adapter, cable modem, Wi-Fi adapter, cellular transceiver, Bluetooth transceiver, or the like, or a combination thereof. Depending on the specific nature and purpose of the processing system 800, the I/O devices 808 can include devices such as a display (which may be a touch screen display), audio speaker, keyboard, mouse or other pointing device, microphone, camera, etc.

While processes or blocks are presented in a given order, alternative embodiments may perform routines having steps or employ systems having blocks, in a different order, and some processes or blocks may be deleted, moved, added, subdivided, combined and/or modified to provide alternative or sub-combinations, or may be replicated (e.g., performed multiple times). Each of these processes or blocks may be implemented in a variety of different ways. In addition, while processes or blocks are at times shown as being performed in series, these processes or blocks may instead be performed in parallel or may be performed at different times. When a process or step is “based on” a value or a computation, the process or step should be interpreted as based at least on that value or that computation.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., ROM, RAM, magnetic disk storage media, optical storage media, flash memory devices), etc.

Note that any and all of the embodiments described above can be combined with each other, except to the extent that it may be stated otherwise above, or to the extent that any such embodiments might be mutually exclusive in function and/or structure. Although the present invention has been described with reference to specific exemplary embodiments, it will be recognized that the invention is not limited to the embodiments described but can be practiced with modification and alteration within the spirit and scope of the disclosed embodiments. Accordingly, the specification and drawings are to be regarded in an illustrative sense rather than a restrictive sense.

Physical and functional components (e.g., devices, engines, modules, and data repositories) associated with processing system 800 can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer-readable data storage. The tangible storage memory may be volatile or non-volatile memory. In some embodiments, the volatile memory may be considered “non-transitory” in the sense that it is not a transitory signal. Memory space and storage described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method steps or a method step of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implement a portion of the functional components). Other arrays, systems and devices described above may include additional, fewer, or different functional components for various applications.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

Although this disclosure generally described embodiments in the context of telecommunications services, the disclosed techniques can apply in a variety of other contexts that can benefit from offline charging by maintaining usability of rated services while mitigating revenue losses that result from an inability to perform online metering.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements, blocks and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways.

Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms.

Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology

FIG. 9 illustrates examples of various computing platforms configured to provide various functionalities to components of a resource management optimization service to optimize resource deployment over multiple service lines. Computing platform 900 may be used to implement computer programs, applications, methods, processes, algorithms, or other software, as well as any hardware implementation thereof, to perform the above-described techniques.

In some cases, computing platform 900 or any portion (e.g., any structural or functional portion) can be disposed in any device, such as a computing device 990a, mobile computing device 990b, and/or a processing circuit in association with initiating any of the functionalities described herein, via user interfaces and user interface elements, according to various examples.

Computing platform 900 includes a bus 902 or other communication mechanism for communicating information, which interconnects subsystems and devices, such as processor 904, system memory 906 (e.g., RAM, etc.), storage device 908 (e.g., ROM, etc.), an in-memory cache (which may be implemented in RAM 906 or other portions of computing platform 900), a communication interface 913 (e.g., an Ethernet or wireless controller, a Bluetooth controller, NFC logic, etc.) to facilitate communications via a port on communication link 921 to communicate, for example, with a computing device, including mobile computing and/or communication devices with processors, including database devices (e.g., storage devices configured to store atomized datasets, including, but not limited to triplestores, etc.). Processor 904 can be implemented as one or more graphics processing units (“GPUs”), as one or more central processing units (“CPUs”), such as those manufactured by Intel® Corporation, or as one or more virtual processors, as well as any combination of CPUs and virtual processors. Computing platform 900 exchanges data representing inputs and outputs via input-and-output devices 901, including, but not limited to, keyboards, mice, audio inputs (e.g., speech-to-text driven devices), user interfaces, displays, monitors, cursors, touch-sensitive displays, touch-sensitive input and outputs (e.g., touch pads), LCD or LED displays, and other I/O-related devices.

Note that in some examples, input-and-output devices 901 may be implemented as, or otherwise substituted with, a user interface in a computing device associated with, for example, a user account identifier in accordance with the various examples described herein.

According to some examples, computing platform 900 performs specific operations by processor 904 executing one or more sequences of one or more instructions stored in system memory 906, and computing platform 900 can be implemented in a client-server arrangement, peer-to-peer arrangement, or as any mobile computing device, including smart phones and the like. Such instructions or data may be read into system memory 906 from another computer readable medium, such as storage device 908. In some examples, hard-wired circuitry may be used in place of or in combination with software instructions for implementation. Instructions may be embedded in software or firmware. The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks and the like. Volatile media includes dynamic memory, such as system memory 906.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by computing platform 900. According to some examples, computing platform 900 can be coupled by communication link 921 (e.g., a wired network, such as LAN, PSTN, or any wireless network, including WiFi of various standards and protocols,

Bluetooth®, NFC, Zig-Bee, etc.) to any other processor to perform the sequence of instructions in coordination with (or asynchronous to) one another. Computing platform 900 may transmit and receive messages, data, and instructions, including program code (e.g., application code) through communication link 921 and communication interface 913. Received program code may be executed by processor 904 as it is received, and/or stored in memory 906 or other non-volatile storage for later execution.

In the example shown, system memory 906 can include various modules that include executable instructions to implement functionalities described herein. System memory 906 may include an operating system (“O/S”) 932, as well as an application 936 and/or logic module(s) 959. In the example shown in FIG. 9, system memory 906 may include any number of modules 959, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any.

As software, the above-described techniques may be implemented using various types of programming or formatting languages, frameworks, syntax, applications, protocols, objects, or techniques. These can be varied and are not limited to the examples or descriptions provided.

In some embodiments, modules 959 of FIG. 9, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 959 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 959 or one or more of its/their components, or any process or device described herein, can be implemented in one or more computing devices (i.e., any mobile computing device, such as a wearable device, such as a hat or headband, or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, modules 959 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving, at an optimization engine, a request to deploy a resource to perform a service for a service line of a plurality of service lines, wherein each service line is operable independent of any other service line, and wherein the resource belongs to a pool of resources and each resource is associated with a plurality of features that reflect suitability for any of the plurality of service lines;
mediating, at the optimization engine, the request to identify one or more suitable resources that satisfy the request, wherein suitability of any resource is determined based on the plurality of features; and
deploying, at the optimization engine, an identified resource that satisfies the request for the service line, wherein the identified resource is deployable among at least two or more of the service lines.

2. The method of claim 1, wherein the plurality of features comprises a plurality of learned features.

3. The method of claim 2, wherein identifying the one or more suitable resources comprises.
determining the suitability of a resource based on the plurality of learned features, the plurality of learned features being output of a predictive data model based on inputs indicative of data representing interactions between the plurality of service lines and the pool of resources.

4. The method of claim 2, wherein identifying the one or more suitable resources comprises.
analyzing statistically one or more components of interaction message data and the plurality of features.

5. The method of claim 4, further comprising:
predicting data representing a value indicative of a capacity of another resource; and
modifying a subset of learned feature data to implement the another resource,
wherein the resource and the another resource are assigned to different service lines.

6. The method of claim 1, further comprising:
monitoring utilization and performance of the identified resource relative to the service line.

7. The method of claim 6, further comprising:
updating the plurality of features based on the monitored utilization and performance of the identified resource relative to the service line.

8. The method of claim 1, wherein the plurality of features includes data representing one or more of profile data value, a skill and certification data value, a schedule of resource availability data value, a talent and performance management data value, a subcontractor management data value, algorithmic data, and a supply and demand management data value.

9. The method of claim 1, wherein the request is based on one or more of a resource utilization data value, data representing an assignment to a project, data representing an assignment to a case, data representing an assignment to break/fix-modeled task, data representing an assignment to a managed service request, data representing a schedule of utilization based on time, and data representing an update of progress of an activity in which a the resource is engaged.

10. A system comprising:
a resource management optimization system including a data store configured to store executable instructions and data, and a processor configured to execute instructions, the resource management optimization system configured to interface with a plurality of disparate computing platforms configured to provide one or more portions of different service lines, at least one platform being a cloud platform, the processor being configured to:
receive a request to deploy a resource to perform a service for a service line of a plurality of service lines, wherein each service line is operable independent of any other service line, and wherein the resource belongs to a pool of resources and each resource is associated with a plurality of features that reflect suitability for any of the plurality of service lines;
mediate the request to identify one or more suitable resources that satisfy the request, wherein suitability of any resource is determined based on the plurality of features; and
deploy an identified resource that satisfies the request for the service line, wherein the identified resource is deployable among at least two or more of the service lines.

11. The system of claim 10, wherein the plurality of features comprises a plurality of learned features.

12. The system of claim 11, wherein the processor is further configured to:
determine the suitability of a resource based on the plurality of learned features, the plurality of learned features being output of a predictive data model based on inputs indicative of data representing interactions between the plurality of service lines and the pool of resources.

13. The system of claim 11, wherein the processor is further configured to:
analyze statistically one or more components of interaction message data and the plurality of features.

14. The system of claim 13, wherein the processor is further configured to:
predict data representing a value indicative of a capacity of another resource; and
modify a subset of learned feature data to implement the another resource,
wherein the resource and the another resource are assigned to different service lines.

15. The system of claim 10, wherein the processor is further configured to:
monitor utilization and performance of the identified resource relative to the service line.

16. The system of claim 15, wherein the processor is further configured to:
update the plurality of features based on the monitored utilization and performance of the identified resource relative to the service line.

17. The system of claim 10, wherein the plurality of features includes data representing one or more of profile data value, a skill and certification data value, a schedule of resource availability data value, a talent and performance management data value, a subcontractor management data value, algorithmic data, and a supply and demand management data value.

18. The system of claim 10, wherein the request is based on one or more of a resource utilization data value, data representing an assignment to a project, data representing an assignment to a case, data representing an assignment to break/fix-modeled task, data representing an assignment to a managed service request, data representing a schedule of utilization based on time, and data representing an update of progress of an activity in which a the resource is engaged.
